(19) United States
(12) Patent Application Publication
(10) Pub. No.: US 2017/0038489 A1
(43) Pub. Date: Feb. 9, 2017

(54) Fracture-Size-Correlated Aperture Mapping for Localized Porosity and Permeability Determination

(71) Applicant: Halliburton Energy Services, Inc., Houston, TX (US)

(72) Inventors: Yogendra Narayan PANDEY, Houston, TX (US); Genbao SHI, Sugar Land, TX (US); Jeffrey Marc YARUS, Houston, TX (US); Veronica LICERAS, Katy, TX (US)

(73) Assignee: Halliburton Energy Services, Inc., Houston, TX (US)

(21) Appl. No.: 14/908,758

(22) PCT Filed: Apr. 6, 2015
(86) PCT No.: PCT/US2015/024544

§ 371 Date: Jan. 29, 2016

(51) Int. Cl. G01V 1/28; E21B 41/00; G01V 1/40

(52) U.S. Cl. CPC G01V 1/282; G01V 1/40; E21B 41/0092; G01N 15/08

(57) ABSTRACT

A geomodeling method embodiment includes: (a) obtaining a model of a subsurface region having a reservoir, the model including a discrete fracture network; (b) determining an aperture map for each fracture in the discrete fracture network, each aperture map having aperture values based at least in part on a lateral dimension of the fracture; (c) for each of a plurality of cells in the model: (c1) identifying a portion of the discrete fracture network contained within the given cell; (c2) deriving a fracture permeability from aperture maps for the identified portion; and (c3) calculating a fracture porosity from aperture maps for the identified portion; and (d) displaying the fracture porosity and fracture permeability as a function of position throughout the sub surface region.

### BACKGROUND

Seismology is used for exploration, archaeological studies, and engineering projects that require geological information. Exploration seismology provides data that, when used in conjunction with other available geophysical, borehole, and geological data, can provide information about the structure and distribution of rock types and their contents. Such information greatly aids searches for water, geothermal reservoirs, and mineral deposits such as hydrocarbons and ores. Most oil companies rely on exploration seismology to select sites in which to drill exploratory oil wells.

Traditional seismology employs artificially generated seismic waves to map structures within a subsurface region. The seismic waves propagate from a source down into the earth and reflect from boundaries between subsurface structures. Surface receivers detect and record reflected seismic waves for later analysis. Typically, the recorded signals from each shot (i.e., each firing of the source) are processed to form a depth-based partial image of the subsurface. The partial images are overlapped and added (“stacked”) to form a volumetric image of the subsurface boundaries that delineate the formation layers and other structures. The properties of each layer or other structure are then determined from a variety of sources including further processing of the seismic signals, direct measurement via borehole logs and core samples, and interpretation by professional geologists.

The resulting geologic model is of great value to for identifying subsurface features of interest (including reservoirs), evaluating development strategies, and optimizing the execution of those strategies. Among the common uses of such models is determining the production potential of various well arrangements drilled in and around hydrocarbon reservoirs. Such determinations typically involve the simulation of fluid flows from the formation matrix into the wellbores to estimate hydrocarbon production rates and volumes. Of particular interest to such simulations are the formation porosity and permeability values as a function of position throughout the reservoir-containing region.

A potentially complicating factor for many formations (particularly the increasingly important shale plays) is the presence of natural fractures that may serve as fluid flow paths or storage mechanisms that dominate, or at least modify, the effective porosity and/or permeability of the matrix material. Fractures tend to be two dimensional in nature, having a thickness (“aperture”) that is much smaller than their lateral (length and width) dimensions, and as such they require special handling when dealing with flow simulations that typically consider a coarse volumetric block as the foundational unit. One approach embraced by the literature is the use of a volumetric block model augmented with a discrete fracture network (DFN). The DFN represents the fractures as two-dimensional surfaces embedded in the volumetric block model.

Often, the fractures are presumed to be flat rectangles, though some representations enable fractures to be represented as a tessellated surface that may have an irregular shape and may be curved or wavy (i.e., not planar). In either case, the existing literature appears to provide each fracture with an assumed aperture (often derived from a statistical distribution) that is constant across the whole surface of the fracture, with different fractures having different aperture values or varying randomly across the fracture surface without any physical correlation. These approaches neglect certain physics-based realities of fracture geometries, introducing inescapable inaccuracies to the models and results derived with this approach.

### BRIEF DESCRIPTION OF THE DRAWINGS

Accordingly, there are disclosed in the drawings and the following description geologic modeling systems and methods that employ fracture-size-correlated aperture mapping and that further employ the aperture maps as the basis for determining localized fracture porosity and permeability tensors. In the drawings:

FIG. 1 is a block diagram of an illustrative geologic modeling system.

FIG. 2A is an isometric view of an illustrative subsurface region.

FIG. 2B is an isometric view of an illustrative volumetric model representing the subsurface region.

FIG. 3A is a detail view of a model cell having a portion of a discrete fracture network.

FIG. 3B is a tessellated representation of one fracture.

FIG. 4 is a flowchart of an illustrative geologic modeling method.

FIG. 5A is a flattened representation of a fracture.

FIG. 5B is a view of the flattened representation with superimposed bins.

FIG. 5C is the flattened representation having tessellations associated with individual bins.

FIG. 6 is a mapping of tessellation coordinates to aperture values.

It should be understood, however, that the specific embodiments given in the drawings and detailed description thereto do not limit the disclosure, but on the contrary, they provide the foundation for one of ordinary skill to discern the alternative forms, equivalents, and modifications that are encompassed with the given embodiments by the scope of the appended claims.

### DETAILED DESCRIPTION

The disclosed systems and methods are best understood in an illustrative context. We begin here with a brief discussion of the hardware that commonly embodies the tools of the geologic modeling profession. FIG. 1 shows a computer system including a personal workstation 102. The workstation 102 may take the form of a desktop computer having a user interface (e.g., keyboard, mouse, and display) that enables the user to interact with the system, entering commands and viewing responses. In this fashion, the user is able to load seismic data into the system, to configure and monitor the processing of the data to obtain and store geologic models, to subject those models to additional processing for refinement, and to use those models for evaluating production strategies via simulation of potential production operations.

Generally, workstation 102 lacks sufficient internal resources to perform such processing in a timely fashion. A local area network (LAN) 104 couples the workstation 102 to one or more multi-processor computers 106, which are in turn coupled via a storage area network (SAN) 108 to one or more shared storage units 110. LAN 104 provides high-speed communication between multi-processor computers 106 and with personal workstation 102. The LAN 104 may take the form of an Ethernet network.

Multi-processor computer(s) 106 provide parallel processing capability to enable suitably prompt processing of the seismic and geologic model data. Each computer 106 includes multiple processors 112, distributed memory 114, an internal bus 116, a SAN interface 118, and a LAN interface 120. Each processor 112 operates on allocated tasks to solve a portion of the overall problem and contribute to at least a portion of the overall results. Associated with each processor 112 is a distributed memory module 114 that stores application software and a working data set for the processor's use. Internal bus 116 provides inter-processor communication and communication to the SAN or LAN networks via the corresponding interfaces 118, 120. Communication between processors in different computers 106 can be provided by LAN 104 or via a mailbox mechanism on storage devices 110.

SAN 108 provides low-latency access to shared storage devices 110. The SAN 108 may take the form of, e.g., a Fibrechannel or Infiniband network. Shared storage units 110 may be large, stand-alone information storage units that employ magnetic disk media for nonvolatile data storage. To improve data access speed and reliability, the shared storage units 110 may be configured as a redundant disk array (“RAID”).

It is the software that configures the various parts of the computer system to coordinate and collectively operate as a geologic modeling (“geomodeling”) system. One or more proprietary or commercially available software packages may be installed in the computer system to provide the desired functionality. User-authored scripts, workflows, or other programming mechanisms may be employed to customize the operation of the software and automate certain operations such as those outlined below for fracture-size-correlated aperture mapping and localized porosity and permeability determinations. Examples of commercially available software that supports the use of such user programming include Paradigm's GOCAD software, which supports the use of TCL (“Tool Command Language”) or CLI (“Command Language Interface), and Schlumberger's Petrel software, which includes a Process Manager for authoring workflows. Both software packages support the use of plug-ins that can be authored in traditional programming languages such as C++. Nevertheless, the implementation of the following methods is not limited to any specific software language or execution environment.

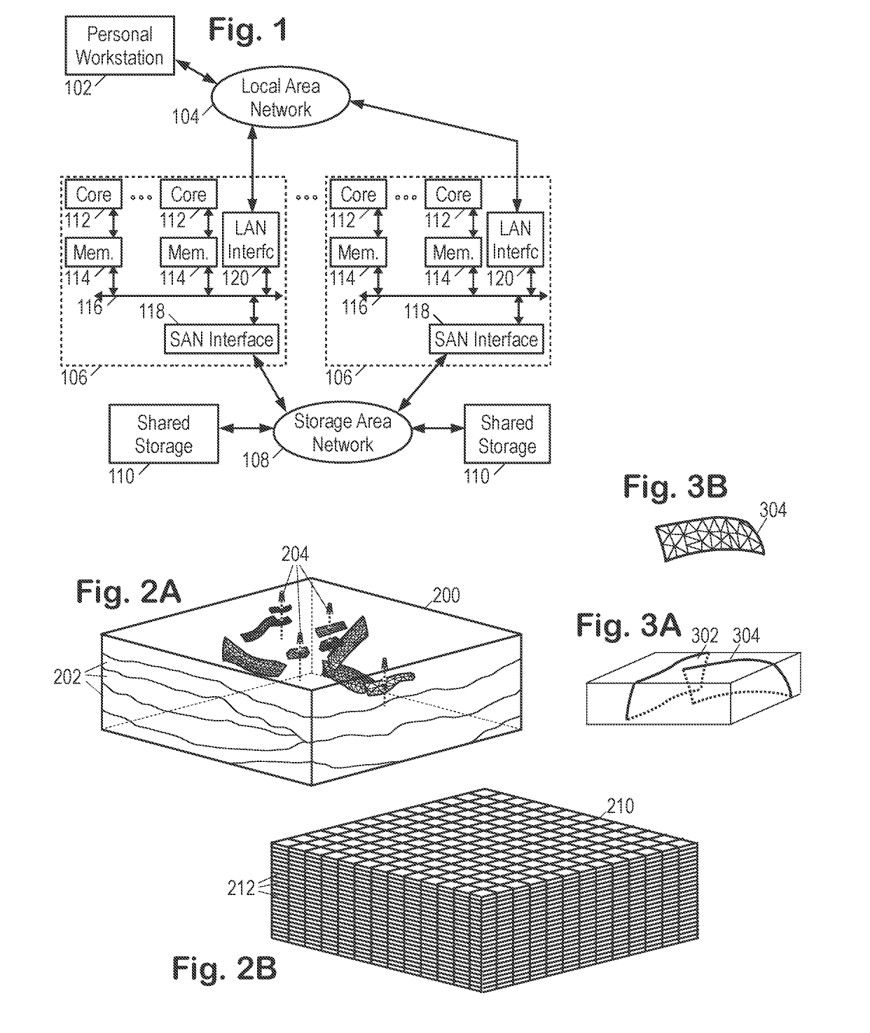

FIG. 2a is a representation of a subsurface region of interest 200 having formation beds 202 and other subsurface structures, potentially including a naturally fractured reservoir. Various wells 204 may be proposed or already in existence for producing from the reservoir. To evaluate the effectiveness of the well placement and other customizable parameters of the reservoir development and production strategy, the subsurface region of interest 200 is represented by a geologic model 210 that is gridded or otherwise divided into volumetric cells 212. Each cell is assigned a representative value of a seismic attribute and/or other formation properties (e.g., porosity, permeability), enabling the model 210 to represent the spatial variation of those properties throughout the region of interest. Typically, the model is initially based on seismic attributes such as reflectivity, acoustic impedance, acoustic velocity, and density, and gains additional parameter values as additional data and processing enable the model to be refined. The uniform grid data format lends itself to computational analysis and visual rendering at each stage of the processing.

To enable the model to be developed and refined in a reasonable amount of time, and to make it useful for fluid flow simulations, it is necessary to limit the number of cells 212. Generally, this restriction causes the cells to have sizes on the order of 10 meters or more. While it is not unusual for fractures to have lateral dimensions on this scale, their apertures are typically on the order of millimeters (or fractions of millimeters) making them essentially invisible despite their influence on formation permeability and porosity. FIG. 3a shows an illustrative cell having internal fractures 302, 304, represented as two-dimensional surfaces. Fractures 302, 304 are just the portion of the fractures represented by a discrete fracture network (“DFN”) component of the geomodel 210, that portion which intersects with the illustrated volumetric cell. To allow for bending and curvature of the fractures, each fracture is represented by a tessellation, e.g., a triangular mesh representation of the fracture 304 as shown in FIG. 3b. Other surface representation techniques are known and suitable for use in the disclosed systems and methods, including rectangular and hexagonal meshes, irregular tessellations, and point cloud representations.

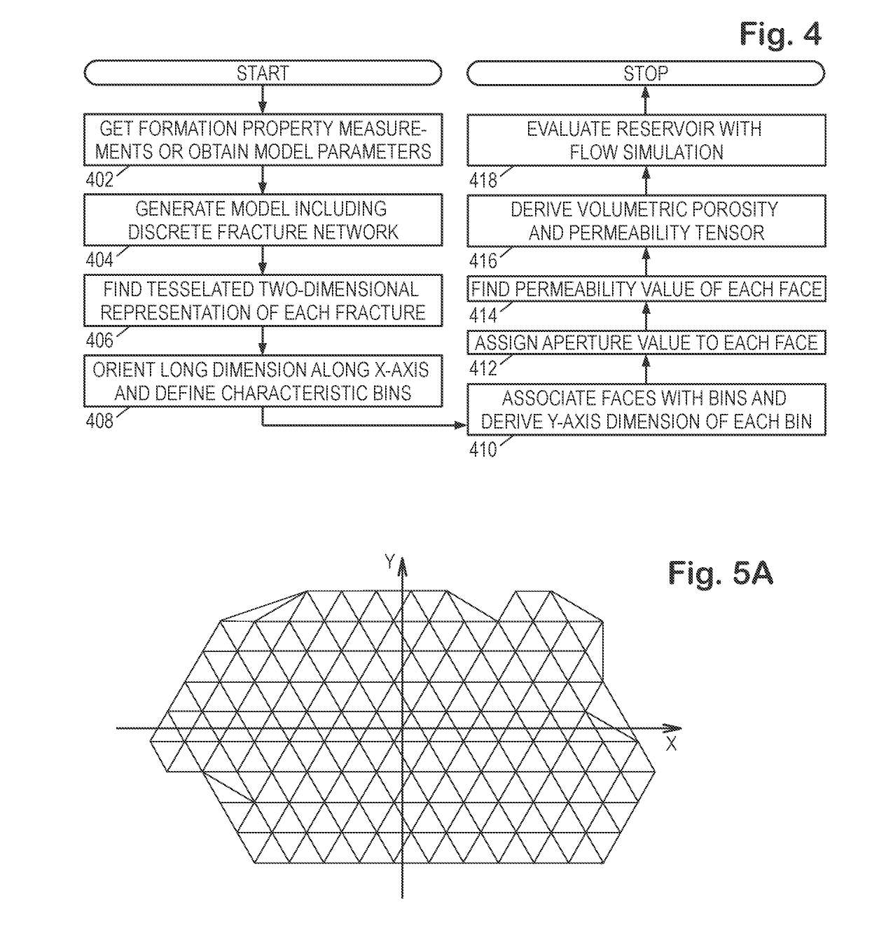

With the foregoing context in mind, FIG. 4 shows a flowchart of an illustrative geomodeling method employing fracture-size-correlated aperture mapping. It begins in block 402 with the geomodeling system obtaining information about formation properties in the region of interest (including fractures), e.g., by accessing databases of seismic survey data and borehole logs. In many cases, detailed fracture maps are not available. In such cases, the distribution of fractures may be characterized statistically and the statistical parameters employed to generate (via stochastic propagation through estimated stress fields) simulated fracture networks in the region of interest.

In block 404 the geomodeling system processes the measurement data to derive a volumetric model of the region of interest, including a DFN. The DFN has a two-dimensional representation of each fracture as a (potentially curved or wavy) surface. If not already standardized in a suitable form, this representation is standardized by the system in block 406. In the contemplated embodiment, the standardized representation is flat, triangular mesh representation of the fracture, obtained by projecting the DFN triangular-mesh representation of the fracture onto a plane. In the contemplated embodiment, the plane is defined by a first line between the farthest-separated vertices of the DFN representation, and a second, perpendicular line to the vertex farthest from the first line. Other projections are also contemplated, as are non-projected two-dimensional representations (e.g., parametric representations).

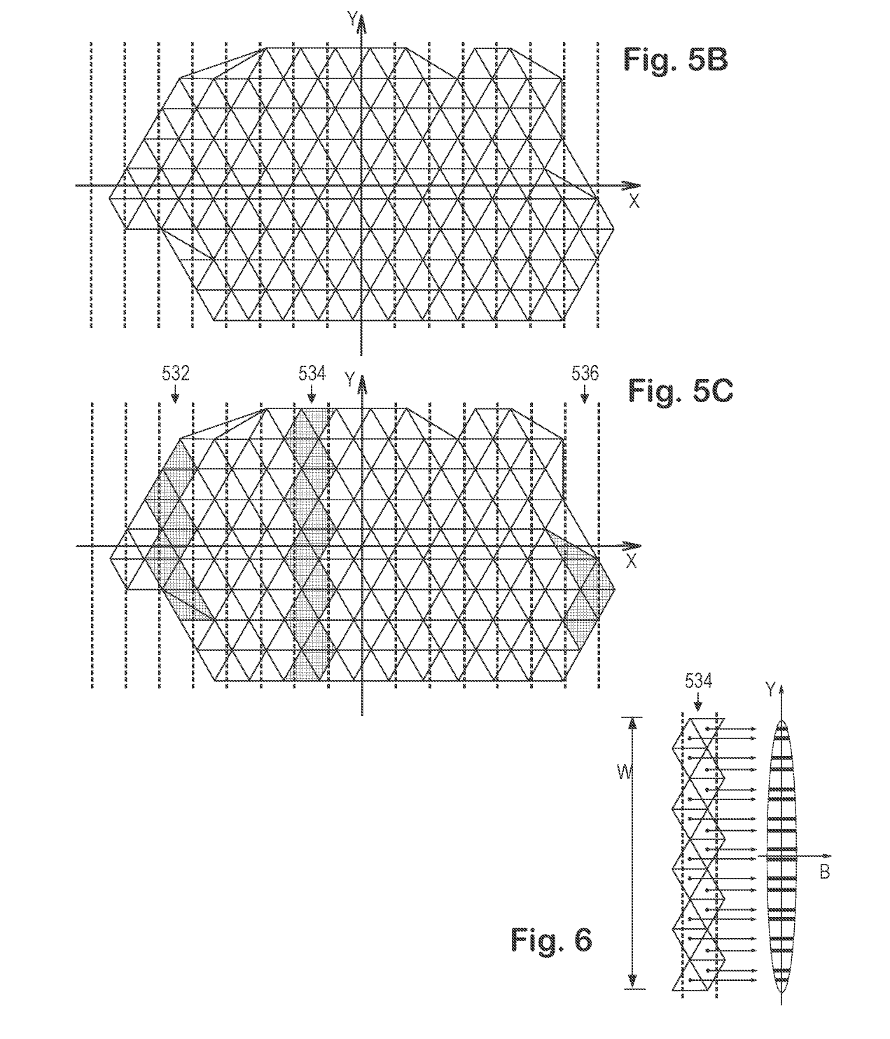

In block 408, the system orients the standardized representation within the plane to place a long dimension of the representation parallel to the x-axis. It is possible to use the first line from the previous block as the x-axis. However, the contemplated embodiment orients the x-axis parallel to the greater of the two characteristic dimensions called strike length (Lₛₜᵣᵢₖₑ) and dip length (L_{dip}). Other orientation techniques are also suitable, so long as the x-axis is generally aligned with the longest lateral dimension of the fracture as shown in FIG. 5a. The origin of the coordinate axes is placed at the center of the fracture representation, which can be calculated as the average of the x coordinates and the average of the y coordinates.

Also in block 408, the system defines bins along the x-axis. The bin size is preferably chosen to approximately equal the characteristic width of the tessellation faces so that the bins effectively divide the representation into columns approximately one tile wide. In FIG. 5b, the bins are shown having a size equal the average edge length. These alignment and binning operations enable the system to account for the anisotropic rock properties that cause natural fractures to deviate from idealized circular or rectangular fracture shapes.

In block 410, the system processes the standard representation of each fault to associate each face with a corresponding bin. In the contemplated embodiment, the face centers (the average of the three vertices defining each face) are employed for this purpose, assigning each face to the bin that includes the face center. FIG. 5c uses crosshatching to show the faces assigned to bins 532, 534, and 536.

Once each face has an assigned bin, the system determines the width of the fracture in each bin. FIG. 6 illustrates the width W of the fracture in bin 534. The width may be calculated as the difference between the maximum and minimum y-coordinate values of the vertices of the faces in bin 534. Alternative width measures are also contemplated, including the maximum distance between face centers in bin 534.

In block 412, the system generates an aperture map by assigning a localized aperture value to each face of the fracture representation. In at least some contemplated embodiments, this task is performed geometrically, whereas other contemplated embodiments this task is performed statistically to correlate the aperture values to the fracture size. In one of the geometry-based embodiments, the system models the fracture cross-section as an ellipse as shown in FIG. 6. The major axis of the ellipse extends from the fracture's top edge to its bottom edge (and thus has a length equal to the fracture width W). Note that the ellipse is not in general centered on the x-axis. For example, the ellipse for the faces in bin 536 (FIG. 5c) would be almost entirely below the x-axis.

The minor axis of the ellipse is sized based on the fracture width in accordance with a correlation relationship such as:

$${b}_{max} = \frac{4}{π} {FW}^{κ}$$

where bₘₐₓ is the length of the minor axis in millimeters, F is a constant, W is the fracture width in millimeters, k is an exponent that lies between 0.5 and 2, and the fraction is a scale factor to account for the difference between average fracture aperture and maximum aperture. The correlation relationship parameters are user selected based on experience, measurements of core samples, or borehole logs. Additional information on fracture-size/aperture correlation relationships can be found in the literature, including e.g., S. P. Neuman, “Multiscale relationships between fracture length, aperture, density and permeability,” Geophysical Research Letters, vol. 35, no. 22, p. L22402, 2008; and S. L. Philipp, F. Afsar and A. Gudmundsson, “Effects of mechanical layering on hydrofracture emplacement and fluid transport in reservoirs,” Frontiers in Earth Science, vol. 1, no. 4, 2013.

To determine the aperture value for each face in the representation of the fracture, the face center is taken as the representative point for the entire face. With yⱼ representing the y-axis coordinate of the face center for face j adjusted for the offset between the center of the ellipse and x-axis, and Wᵢ and b_{max,i} representing the lengths of the ellipse's major and minor axes in bin i, the aperture value for face j is

$${b}_{j} = {b}_{max , i} \sqrt{( 1 - {( \frac{2 {y}_{j}}{{W}_{i}} )}^{2} )} .$$

That is, the aperture value for the face corresponds to the width of the ellipse at the y coordinate of its face center, as shown in FIG. 6. This approach to generating localized aperture values provides elliptical fracture openings following a deterministic scheme.

Another contemplated system assigns localized aperture values using a geostatistical technique such as Sequential Gaussian Simulation (SGS), Turning Band Simulation or Multivariate simulation versions of these methods. This approach allows for the creation of multiple solutions (realizations) that are equally probable, thereby measuring potential uncertainty in the model. These techniques employ a random path passing through all face centers in the fracture. Constraining the aperture values at the fracture boundaries to be zero, these techniques “walk” the random paths, assigning to each face an aperture value drawn from a probability distribution with the desired mean, variance, and spatial co-variance parameter values. These parameter values may be derived from measurements of existing fracture apertures in core samples or studies in the literature (or variograms thereof), derived from simulated fracture propagations, or specified by the user. The probability distribution parameter values that describe fracture apertures may be correlated to fracture width, average aperture size, fracture position (horizontal and vertical), fracture density and other descriptive variables.

In block 414, the system calculates a localized permeability value for each face j. Under an assumption of laminar flow, the permeability for flow along the fracture is:

Kⱼ=bⱼ²/12

However, when the flow direction is not aligned with the fracture, the localized permeability value changes in accordance with the angle α between the flow vector and the normal to the elliptical aperture opening encompassing face j (FIG. 6)

$${K}_{j} = \frac{{b}_{j}^{2}}{12} {cos}^{2} α$$

(See T. D. v. Golf-Racht, Fundamentals of fractured reservoir engineering by T. D. van Golf-Racht, Elsevier Amsterdam; New York, 1982, pp. 147-157.) This latter expression is used by the system when determining the directionally-dependent components of the permeability tensor in block 416. Alternatively, the directional dependence may be neglected (i.e., the system assumes that the flow direction is always oriented along the fracture) to obtain a scalar permeability value for each face.

In block 416, the system intersects the discrete fracture network with volumetric cells from the geomodel. The system integrates over the fracture faces within each given cell to derive a total permeability tensor or scalar value for that cell. The system further integrates over the fracture faces to obtain the total face volume (the volume of each face j is the product of the aperture bⱼ with the face area Aⱼ). This integral, when divided by the cell volume V_{cell}, yields the fracture porosity:

$${Φ}_{f} = {\sum }_{j ∈ cell} {A}_{j} {b}_{j} / {V}_{cell} .$$

This equation can also be viewed as the expressing a localized porosity value for each face j of the fracture representation:

φ_{f,j}=Aⱼbⱼ/V_{cell}

In this fashion (i.e., the association of localized porosity and permeability values with the faces of the fracture representations), the system converts a fracture's aperture map into a fracture porosity map and a fracture permeability map. These maps can be viewed or, as discussed previously, aggregated to obtain values for the cells of the volumetric model.

In block 418, the system takes the fracture permeability and fracture porosity values of the volumetric cells, along with any other significant sources of permeability and porosity (such as the matrix material pores), and uses them to evaluate any reservoirs in the region of interest. Such evaluation typically involves a determination of fluid saturations (including what percentages of the formation fluid consist of hydrocarbons), a determination of in-place hydrocarbon volume or density, and fluid flow simulations to determine the producible hydrocarbon volume and rate for various well configurations.

The flow simulations for Type-I reservoirs, where the fractures are the primary source of hydrocarbon storage capacity and serve as the primary flow paths, it may be sufficient to consider only the fracture properties when performing an evaluation. However, in Type-II reservoirs, the matrix porosity dominates the hydrocarbon storage, and in Type-III reservoirs, the matrix provides the primary flow paths. Thus evaluations for Type-II and Type-III reservoirs must necessarily consider the matrix properties in addition to the fracture properties.

Often, the simulations employ a 3D (or hybrid 2.5D) finite volume (or finite element) approach to solve the flow equations for matrix and fractures separately, complemented with equations modeling the transfer of fluids between matrix and fractures. These simulations may involve finer scale meshing with unstructured gridding that provides very high resolution in the near-fracture region. Alternatively, the fracture and matrix properties may be combined to an equivalent representation in a relatively coarse or upscaled grid.

Results for the fluid flow simulations and other evaluation operations can be visually represented on a computer screen for the user to study and manipulate. Typically, the user will identify potential issues based on these visual representations and conduct further operations to address such issues. Such further operations may include finer-grained simulations, alternative well configurations, potential stimulation treatments, and any other optimizations that may be appear justified based on the available resources.

As previously mentioned, it is contemplated that the operations shown in FIG. 4 may be implemented in the form of software, which can be stored in computer memory, in long-term storage media, and in portable information storage media. It should be noted that illustrative method of FIG. 4 is provided as an explanatory aid. In practice, the various operations shown in FIG. 4 may be performed in different orders and are not necessarily sequential. For example, geomodel processing can benefit substantially from parallelism. In some processing method embodiments, data from different portions of the model may be processed independently. In other embodiments, the operations may be “pipelined” so that operations on individual faults occur in the sequence shown despite the concurrent application of different operations to different faults. Additional operations may be added to the illustrative method and/or several of the operations shown may be omitted.

Numerous other modifications, equivalents, and alternatives, will become apparent to those skilled in the art once the above disclosure is fully appreciated. For example, the correlation between fracture size and aperture may take other forms than the power law given above. The elliptical shape used for geometric determination of localized aperture values may be replaced by other shapes, including oval, tear-drop, and vesica piscis. Rectangular and trapezoidal shapes are also contemplated. The mesh can be formed by any generic geometric polygon shape. It is further contemplated that the assigned apertures may be given a time dependence that in turn introduces time dependence to the localized fracture porosity and permeability values. This time dependence may be used to capture the effects of reservoir drainage and subsidence. It is intended that the following claims be interpreted to embrace all such modifications, equivalents, and alternatives, where applicable.

What is claimed is:

1. A geomodelling method that comprises:
obtaining a model of a subsurface region having a reservoir, the model including a discrete fracture network;
determining an aperture map for each fracture in the discrete fracture network, each aperture map having aperture values based at least in part on a lateral dimension of the fracture;
for each of a plurality of cells in the model:
identifying a portion of the discrete fracture network contained within the given cell;
deriving a fracture permeability from aperture maps for the identified portion; and
calculating a fracture porosity from aperture maps for the identified portion; and
displaying the fracture porosity and fracture permeability as a function of position throughout the subsurface region.

2. The method of claim 1, wherein said calculating includes:
converting each aperture map into a localized fracture porosity map; and
integrating localized fracture porosity map values for the identified portion of the discrete fracture network.

3. The method of claim 1, wherein said deriving includes:
transforming each aperture map into a localized fracture permeability map;
applying directional component weightings to localized fracture permeability map values; and
aggregating weighted localized fracture permeability map values for the identified portion of the discrete fracture network.

4. The method of claim 1, further comprising estimating producible reservoir volume based at least in part on a spatial dependence of the fracture porosity.

5. The method of claim 1, further comprising estimating a reservoir production rate based at least in part on a spatial dependence of the fracture permeability.

6. The method of claim 1, wherein the determining includes using a length-correlated geostatistical technique to associate an aperture value with each face of a tessellated representation of the fracture.

7. The method of claim 6, wherein the geostatistical technique comprises at least one of: kriging, sequential Gaussian simulation, and co-simulation.

8. The method of claim 1, wherein the determining includes using a geometric technique to assign a length-correlated aperture value to each face of a tessellated representation of the fracture.

9. The method of claim 8, wherein the geometric technique assigns aperture values for providing the fracture with an elliptical cross-section.

10. The method of claim 1, wherein the model further includes matrix porosity and matrix permeability values for each cell.

11. A geomodeling system that comprises:
nonvolatile information storage having a model of a subsurface region, the model including a discrete fracture network;
memory having modeling software; and
one or more processors coupled to the memory to execute the modeling software, the software causing the one or more processors to derive spatially-dependent fracture porosity values and spatially-dependent fracture permeability tensor values from the discrete fracture network by:
determining an aperture map for each fracture in the discrete fracture network, each aperture map having aperture values that are based at least in part on a short dimension of the fracture;
for each of a plurality of cells in the model:
identifying a portion of the discrete fracture network contained within the given cell;
deriving a fracture permeability from aperture maps for fractures in that portion; and
calculating a fracture porosity from the aperture maps for fractures in that portion; and
wherein the software further causes the one or more processors to display or store the fracture permeability and fracture porosity as a function of position throughout the subsurface region.

12. The system of claim 11, wherein said calculating includes:
converting each aperture map into a localized fracture porosity map; and
integrating localized fracture porosity map values for the identified portion of the discrete fracture network.

13. The system of claim 11, wherein said deriving includes:
transforming each aperture map into a localized fracture permeability map;
applying directional component weightings to localized fracture permeability map values; and
aggregating weighted localized fracture permeability map values for the identified portion of the discrete fracture network.

14. The system of claim 11, further comprising estimating producible reservoir volume based at least in part on a spatial dependence of the fracture porosity.

15. The system of claim 11, further comprising estimating a reservoir production rate based at least in part a spatial dependence of the fracture permeability.

16. The system of claim 11, wherein the determining includes using a length-correlated geostatistical technique to associate an aperture value with each face of a tessellated representation of the fracture.

17. The system of claim 16, wherein the geostatistical technique comprises at least one of:
kriging, sequential Gaussian simulation, and co-simulation.

18. The system of claim 11, wherein the determining includes using a geometric technique to assign a length-correlated aperture value to each face of a tessellated representation of the fracture.

19. The system of claim 18, wherein the geometric technique assigns aperture values for providing the fracture with an elliptical cross-section.

20. The system, of claim 11, wherein the model further includes matrix porosity and matrix permeability values for each cell.
